(19) United States
(12) Patent Application Publication
(10) Pub. No.: US 2014/0186108 A1
(43) Pub. Date: Jul. 3, 2014

(54) ATTACHMENT DEVICE AND ATTACHMENT ARRANGEMENT FOR ATTACHMENT OF COMPONENTS TO AN ATTACHMENT STRUCTURE OF A MEANS OF TRANSPORT

(71) Applicant: Airbus Operations GmbH, Hamburg (DE)

(72) Inventors: Frank Roese, Hamburg (DE); Maxime Legrand, Hamburg (DE)

(21) Appl. No.: 14/198,092

(22) Filed: Mar. 5, 2014

Related U.S. Application Data
(63) Continuation of application No. PCT/EP2012/003893, filed on Sep. 18, 2012.
(60) Provisional application No. 61/537,608, filed on Sep. 22, 2011.

(30) Foreign Application Priority Data
Sep. 22, 2011 (DE) 102011114098.4

(51) Int. Cl. F16B 17/00

(52) U.S. Cl. CPC F16B 17/00
USPC 403/373

(57) ABSTRACT

An attachment device for attachment of components to an attachment structure of a means of transport, in particular to an attachment structure of an aircraft. The attachment device has a clamping unit for introduction into an opening of the attachment structure, and an operating unit connected to the clamping unit for operating the clamping unit. The clamping unit comprises at least one clamping element and at least one elastic element, wherein the at least one elastic element is expandable by a relative movement between the at least one clamping element and the at least one elastic element in an axial direction of the at least one clamping element.

### CROSS-REFERENCES TO RELATED APPLICATIONS

This application is a continuation of International Application PCT/EP2012/003893 filed Sep. 18, 2012, designating the United States and published on Mar. 28, 2013 as WO 2013/041210. This application also claims the benefit of the U.S. Provisional Application No. 61/537,608, filed on Sep. 22, 2011, and of the German patent application No. 10 2011 114 098.4 filed on Sep. 22, 2011, the entire disclosures of which are incorporated herein by way of reference.

### BACKGROUND OF THE INVENTION

The present invention relates to an attachment device and an attachment arrangement for attachment of components to an attachment structure of a means of transport, in particular to an attachment structure of an aircraft.

It is known on the one hand to screw finishing components to the attachment structure present in a means of a transport, such as e.g., an aircraft.

On the other hand, attachment devices of the type disclosed in the document WO 2010/046376 A1 are known from the prior art. The attachment device disclosed in this document for attachment of a finishing component in an aircraft has a second attachment element. The second attachment element comprises a guide element with a connection element, a contact element and a locking element. The connection element of the guide element can be introduced into a first section of a first attachment element. The first attachment element and the second attachment element are brought into a mechanically coupled state by engaging of the first attachment element using the connection element in the second section of the first attachment element. The contact element in the coupled state produces a mechanical contact between the first and the second attachment element. Through operation of the locking element, the first attachment element and the second attachment element can be detachably fixed relative to each other.

### SUMMARY OF THE INVENTION

An object of the present invention is to provide an attachment device and an attachment arrangement for attachment of components to an attachment structure of a means of transport, in particular of an aircraft, by means of which the components to be attached can be affixed quickly and easily to a standardized or specified attachment structure and in particular to standardized openings of the attachment structure.

The attachment device according to the invention for attachment of components to an attachment structure of a means of transport, such as an aircraft, comprises a clamping unit for introduction into an opening of the attachment structure and an operating unit connected to the clamping unit for operation of the clamping unit. The clamping unit comprises at least one clamping element and at least one elastic element, which is expandable by a relative movement between the at least one clamping element and the at least one elastic element in an axial direction of the at least one clamping element.

The relative movement can be both a movement of the clamping element relative to the elastic element and a movement of the elastic element relative to the clamping element.

Expressed another way, the clamping unit of the attachment device can be introduced into an opening of the attachment structure. Via the operating unit a relative movement of the clamping element in particular is initiated in its axial direction relative to the elastic element. Due to this relative movement between the at least one elastic element and the at least one clamping element, the elastic element is expanded. Due to the expansion of the at least one elastic element, a bearing pressure is created, for example, between the clamping unit, in particular the outer peripheral surface of the elastic element, and the opening, in particular the wall of the opening, of the attachment structure, so that the attachment device and thus any components connected to the attachment device can be attached to the attachment structure. In other words, a force-fit connection is produced between the clamping unit and the opening (e.g., an axially effective attachment force) by the bearing pressure.

An attachment structure in this context may be a rail arrangement or frame-like fixture arrangement provided in a means of transport and in particular an aircraft.

The clamping unit and the operating unit are connected to one another, for example, in such a way that a rotary movement of the operating unit about its axis of rotation leads to a displacement of the clamping element in an axial direction of the clamping element. Due to the axial displacement of the clamping element initiated by a rotary movement of the operating unit, the elastic element is expanded accordingly and the attachment device attached to the attachment structure. According to a development, the operating unit may have at least one shaft section, which is connected to the at least one clamping element via a threaded connection.

According to an exemplary embodiment of the invention, the attachment device has at least one casing. The at least one shaft section of the operating unit may be supported rotatably and the clamping element executed e.g., in the form of a shaft supported displaceably in an axial direction in the casing. In this case the casing of the attachment device and the at least one clamping element may be structurally designed in such a way that an anti-twist guard is formed against a twisting of the clamping element. Expressed another way, it is guaranteed by the anti-twist guard that a rotary movement of the operating unit leads to an axial displacement of the clamping unit and the clamping element.

To prevent independent detachment of the attachment device from the attachment structure, the attachment device may be executed with a so-called self-locking mechanism. To this end the shaft section of the operating unit may have, to produce self-locking, at least one projection extending outwards in a radial direction, which projection can be brought to engage with at least one pretensioned spring element arranged at least in sections on an inner peripheral surface of the at least one casing. It should be mentioned with regard to the structural design of the spring element that the spring element may also be executed with at least one projection, which can be brought to engage with the at least one projection of the operating unit. Furthermore, the operating unit may be provided with a structure in the form of a toothed wheel, i.e., a plurality of projections.

Alternatively to the execution described above, at least one projection extending radially inwards may be provided on the inner peripheral surface of the at least one casing of the attachment device, which projection can be brought to engage with at least one pretensioned spring element arranged at least in sections on an outer peripheral surface of the at least one shaft section of the operating unit.

The at least one clamping element of the clamping unit may be executed with at least one section with an increasing cross-section, which is provided for expansion of the elastic element.

For example, the elastic element encompasses the at least one clamping element at least partially. The elastic element is preferably executed in the form of a spring cage, other executions of the elastic element also being conceivable.

The bearing pressure between the clamping unit and the opening of the attachment structure can be increased in that the at least one elastic element has a structured, in particular corrugated outer peripheral surface to increase an axial attachment force. Due to this structured outer peripheral surface, a higher attachment and/or locking force acting in an axial direction can be produced. Furthermore, the elastic element may have an enlarged cross-section in at least one section acting as a retainer. This at least one section with an enlarged cross-section may be executed in the form of a flange, a snap hook or a bulge among other things.

In order to produce and ensure electrical grounding of the apparatuses (components) connected via the attachment device to the attachment structure, at least the at least one casing and/or the at least one elastic element may be executed to be electrically conductive. Due to the electrically conductive execution of the casing and/or of the elastic element, a short-circuit current can be conducted from the apparatuses via the attachment device reliably to the attachment structure, for example of an aircraft, acting as ground.

The invention further relates to an attachment arrangement provided to achieve the object described above for attachment of components to an attachment structure of a means of transport, in particular to an attachment structure of an aircraft. The attachment arrangement comprises here at least one base element provided with at least one opening, to which element the components to be attached can be affixed, at least one attachment device of the type described above, wherein the clamping unit of the at least one attachment device can be introduced at least in sections into the at least one opening of the base element, and at least one covering element, which is assigned to the at least one attachment device and can be affixed to the base element.

According to one embodiment, the at least one covering element can accommodate at least one section of the at least one attachment device with play. The diameter of the at least one opening of the at least one base element is preferably chosen according to this play, can have for example at least play of the same magnitude. A floating mounting of the attachment device is achieved via the play between the covering element and the at least one section of the attachment device. Production tolerances and fitting tolerances on the part of the attachment structure can be compensated for by the floating mounting. The diameter of the at least one opening of the base element may be coordinated to the play between the covering element and the attachment device for tolerance compensation. Expressed another way, the clamping unit formed by the elastic element and the clamping element may also be displaceable up to a certain degree in the opening of the base element, in order to guarantee the floating mounting of the attachment device that is necessary for the tolerance compensation.

The covering element may also have a recess. The recess may be configured in such a way that a section of the casing extending in a radial direction at least in sections can be taken up in the recess with play in a radial and axial direction.

According to a preferred embodiment, the attachment arrangement has a plurality of attachment devices of the type described above, wherein at least one attachment device of the plurality of attachment devices is taken up with play in the covering element assigned to it and at least one further attachment device of the plurality of attachment devices is taken up immovably in the covering element assigned to it. With an attachment arrangement of this kind, the components to be attached can (due to the immobile attachment device) be securely grounded via the attachment structure, as a defined contact between the attachment device and the base element on the one hand and on the other between the base element and the attachment structure can be ensured.

It is conceivable that only one of the plurality of attachment devices is arranged immovably and all others (e.g., three) of the plurality of attachment devices are arranged with play in the covering element assigned to it.

The covering element may be connected fixedly to the base element via attachment means. To improve the grounding of the components to be affixed to the attachment structure and/or to improve the conduction of a short-circuit current to the attachment structure acting as ground, the covering element and/or the attachment means may be executed to be electrically conductive or be coated to be electrically conductive.

### BRIEF DESCRIPTION OF THE DRAWINGS

Preferred embodiments of the present invention are explained schematically below with reference to the enclosed figures. The figures show:

FIG. 1 a view in perspective of the attachment device according to an embodiment of the present invention;

FIG. 2 a sectional view in perspective containing the axis along the longitudinal axis of the attachment device according to the embodiment of the invention from FIG. 1;

FIG. 3 an enlarged detail of a sectional view in perspective of the attachment device according to the embodiment of the invention from FIG. 1;

FIG. 4 a front view of the attachment device according to an embodiment of the invention in FIG. 1;

FIG. 5 a top view of the attachment device according to the embodiment of the invention from FIG. 1;

FIG. 6 a side view of the attachment device according to the embodiment of the invention from FIG. 1;

FIG. 7 a sectional view of the attachment device along the line of intersection A-A from FIG. 5;

FIG. 8 a sectional view of the attachment device along the line of intersection B-B from FIG. 5;

FIG. 9 a sectional view of the attachment device along the line of intersection C-C from FIG. 6;

FIG. 10 a sectional view of the attachment device along the line of intersection D-D from FIG. 6;

FIG. 11 a view in perspective of the attachment arrangement according to an embodiment of the present invention;

FIG. 12 a sectional view of the attachment arrangement along the line of intersection A-A from FIG. 5;

FIG. 13 a sectional view of the attachment arrangement along the line of intersection B-B from FIG. 5;

FIG. 14 a sectional view of the attachment arrangement along the line of intersection C-C from FIG. 6; and

FIG. 15 a sectional view of the attachment arrangement along the line of intersection D-D from FIG. 6.

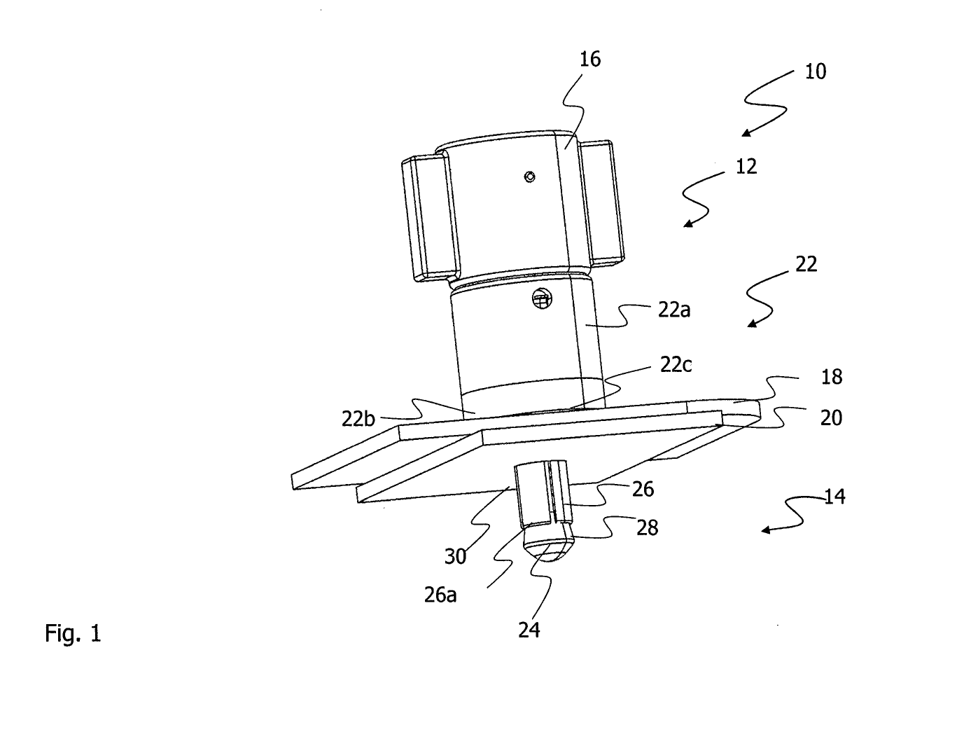

FIG. 1 shows a view in perspective of the attachment device 10 according to an embodiment of the invention.

### DETAILED DESCRIPTION OF THE PREFERRED EMBODIMENTS

The attachment device 10 has an operating unit 12 and a clamping unit 14. Of the operating unit 12, only the handle element 16, by means of which the attachment device 10 can be operated, is shown in FIG. 1.

Also shown in FIG. 1 is a detail of a base element 18, which is not part of the attachment device 10, but can be connected to this via an opening. The base element 18, to which the components to be attached (not shown) can be affixed, can be executed in the form of a component mounting plate or a holding frame for the components. An attachment structure 20, of which a detail is likewise represented in FIG. 1, can be formed for example in the form of rails or an attachment frame. The attachment structure 20 is not part of the attachment device 10 either, but is used so that the base element 18 (and thus the components) can be attached to the attachment structure 20 with the aid of the attachment device 10.

The attachment device 10 comprises a casing 22, which is formed by two casing parts 22a and 22b, the casing part 22b only being shown in sections in FIG. 1. A flange-like section 22c is suggestively recognizable in FIG. 1, which section is provided on the casing part 22b and is placed on the base element 18. The casing parts 22a and 22b can be connected to one another by a press fit or screwing, for example.

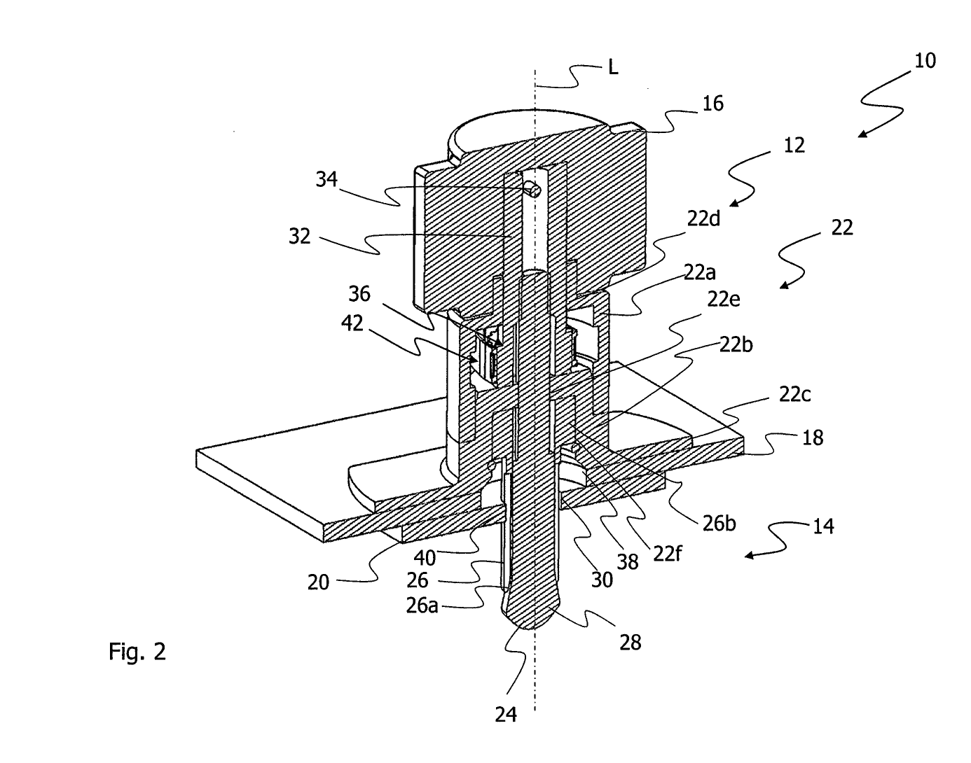

The clamping unit 14 comprises a clamping element 24, which is at least partially encompassed by an elastic element 26. The elastic element 26 is executed in the form of a spring cage, for example, in the embodiment shown. The clamping element 24 has a conical section 28 (see FIG. 2), which is provided for expansion of the elastic element 26. As is recognizable from FIG. 2, the conical section 28 is formed by way of example on one end of the clamping element 24 in the embodiment shown. The conical section 28 of the clamping element 24 is partially encompassed in the inactivated state of the attachment device 10 by an end section 26a of the elastic element 26 and/or the conical section 28 can be partially in contact with the end section 26a.

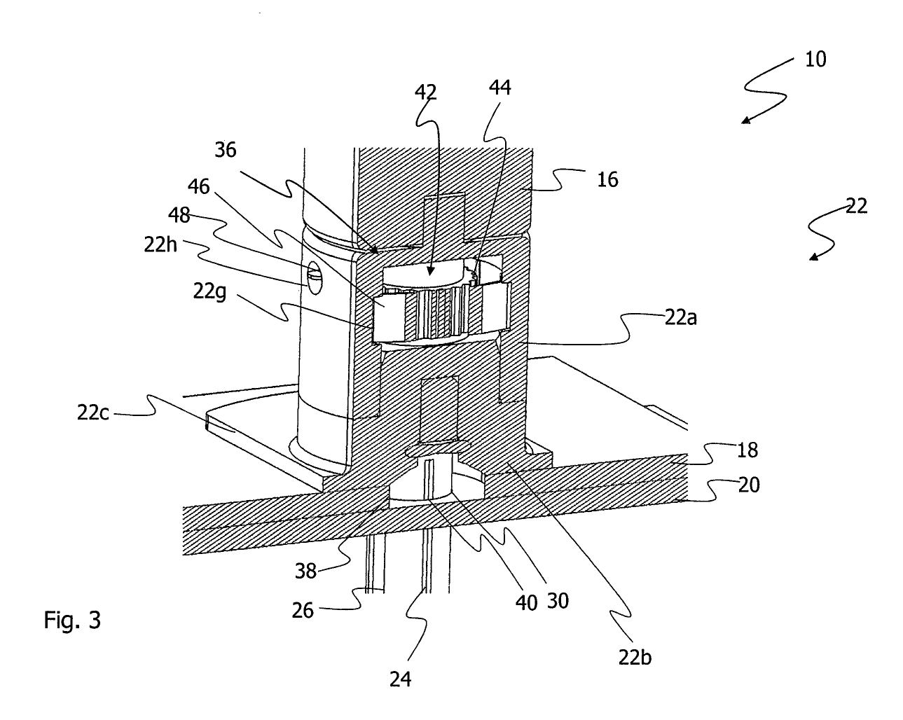

FIG. 1 shows the attachment device 10 in the inactivated state. In the inactivated state, the attachment device 10 and/or the clamping unit 14 can be introduced into an opening, which is not shown (see FIGS. 2 and 3) of the base element 18 and into an opening 30 of the attachment structure 20.

In order to affix the attachment device 10 together with the base element 18, on which the components to be attached (not shown) can be arranged, to the attachment structure 20, the handle element 16 of the operating unit 12 is operated (rotated about its axis of rotation), due to which a relative movement of the clamping element 24 in an axial direction along the longitudinal axis L (see FIG. 2) of the clamping element 24 of the attachment device 10 is initiated relative to the elastic element 26. Due to this relative movement between the clamping element 24 and the elastic element 26, the elastic element 26 is expanded, so that between the elastic element 26 and the opening 30 of the attachment structure 20 or between the elastic element 26 and a wall (see FIGS. 2 and 3) of the opening 30 a bearing pressure arises, which ensures a secure connection of the attachment device 10 to the attachment structure 20. Expressed another way, an axial locking or attachment force is produced by said bearing pressure, which force holds the attachment device 10 together with the base element 18 on the attachment structure 20.

FIG. 2 shows a sectional view in perspective containing the axis along the longitudinal axis of the attachment device 10.

As is seen in FIG. 2, the operating unit 12 comprises a shaft section 32 in addition to the handle element 16. The shaft section 32 is connected to the handle element 16 via a pin 34.

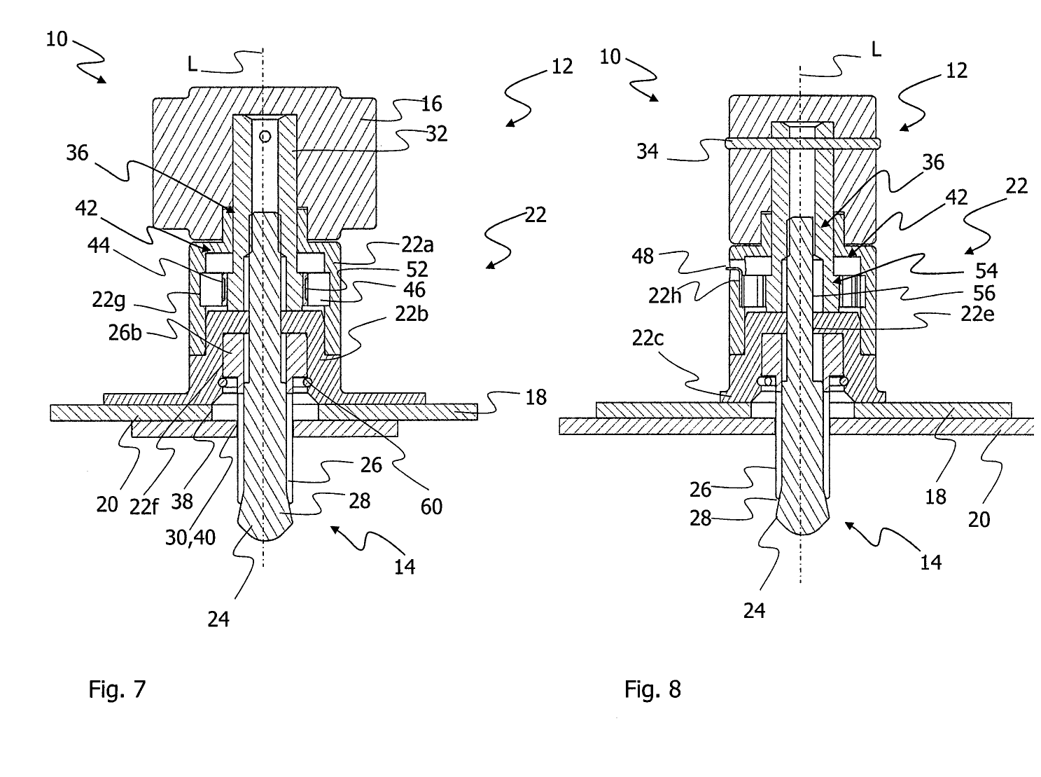

As already mentioned, the clamping unit 14 is formed by the clamping element 24 executed in the form of a shaft and the elastic element 26 encompassing the clamping element 24. The clamping element 24 is connected to the shaft section 32 of the operating unit 12 via a threaded connection (see FIGS. 7 to 10).

The shaft section 32 extends through an opening 22d into the casing part 22a of the casing 22. The clamping element 24 runs through the casing part 22b executed in stepped form and via the opening 22e in the casing part 22b reaches a connection area 36 in the casing part 22a, in which the clamping element 24 is connected to the shaft section 32. In other words, the shaft section 32 and the clamping element 24 are each taken up in sections by the casing 22.

Furthermore, an end section 26b of the elastic element 26 is taken up in a recess 22f. The end section 26b of the elastic element 26 has an enlarged cross-section, so that the elastic element 26 can be secured by means of a retaining ring 27 in the recess 22f of the casing part 22b. The retaining ring 27 is placed here on a section of the elastic element 26 extending radially.

The flange section 22c of the casing part 22b extends in a radial direction outwards around the casing 22 and is formed substantially in the form of a disc. Once the attachment device 10 and the clamping unit 14 have been introduced into an opening 38 of the base element 18 and into the opening 30 of the attachment structure 20, the flange section 22c abuts on the base element 18.

Together with the clamping element 24, the elastic element 26 executed in the embodiment as a spring cage then extends, starting out from the casing 22, through the opening 38 of the base element 18 and the opening 30 of the attachment structure 20. On operation of the operating unit 12 by a rotary movement of the handle element 16 about the longitudinal axis L of the clamping element 24, the clamping element 24 together with its conical section 28 is displaced in an axial direction along the longitudinal axis L of the attachment device 10. The axis of rotation of the operating unit 12 corresponds to the longitudinal axis L of the attachment device 10 and/or of the clamping element 24. In other words, the clamping element 24 executes a relative movement relative to the elastic element 26, in order to expand the elastic element 26 by means of the conical section 28. The expansion of the elastic element 26 by the relative movement of the clamping element 24 causes a bearing pressure (bearing stress) between the elastic element 26 and a wall 40 of the opening 30 of the attachment structure 20. Due to this bearing pressure, the attachment device 10 together with the base element 18 is clamped on the attachment structure 20.

In the connection area 36 between the clamping element 24 and the shaft section 32, a self-locking mechanism 42 is further recognized. The self-locking mechanism 42 is considered in greater detail with reference to FIG. 3.

In order to ensure the grounding of the components affixed to the base element 18, the casing 22 and/or the elastic element 26 can be formed to be electrically conductive or be conductively coated. Due to the electrically conductive formation or coating of the casing 22 and/or of the elastic element 26, it can be ensured that a short-circuit current can be conducted from the components at least from the base element 18 (to which the components are affixed) via the casing 22 and the elastic element 26 to the attachment structure 20 and thus to ground, if the attachment structure is formed conductively only in the peripheral area of the opening 30, for example, and not as a whole.

FIG. 3 shows an enlarged detail of a sectional view in perspective of the attachment device 10.

The self-locking mechanism 42 is now more clearly recognizable in FIG. 3. The self-locking mechanism 42 is provided in the connection area 36. The self-locking mechanism 42 is formed by a toothed wheel section 44 on the shaft section 32 and a spring element 46. The spring element 46 is arranged at least in sections in a groove 22g on an inner peripheral surface of the casing part 22a.

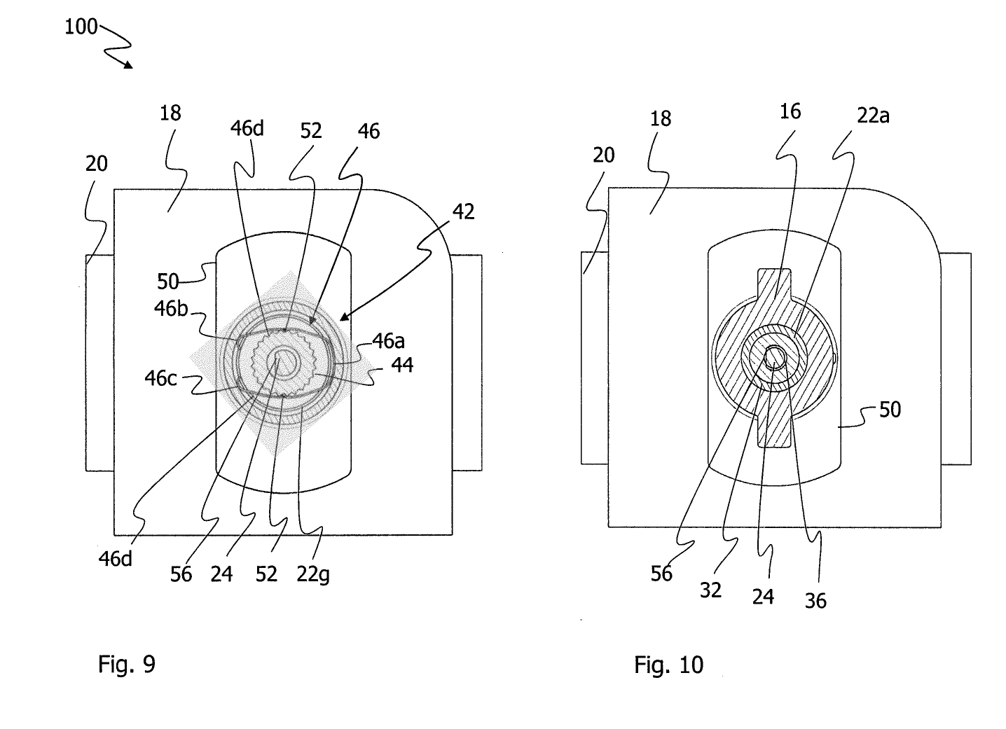

To produce a self-locking, the projections or teeth of the toothed wheel section 44 that extend radially outwards are brought to engage with the spring element 46, which is pretensioned in the direction of the toothed wheel section 44. To do this, the spring element 46 has projections that are offset in relation to one another (see FIG. 9), which engage in the teeth of the toothed wheel section 44.

Independent detachment of the attachment device 10 from the attachment structure 20 is prevented by the self-locking mechanism 42. To this end the projections (see FIG. 9) of the spring element 46 engage under pretensioning in the toothed wheel section 44. If the operating unit 12 is operated by means of a rotary movement, the torque applied by the rotary movement must first exceed the pretensioning force of the spring element 46 in order to facilitate a rotation of the operating unit 12 and operation of the attachment device 10.

An opening 22h in the casing part 22a can also be seen in FIG. 3, through which opening a section 48 of the spring element 46 extends, in order to hold the spring element 46 in its predetermined position and to form an anti-twist guard for the spring element 46.

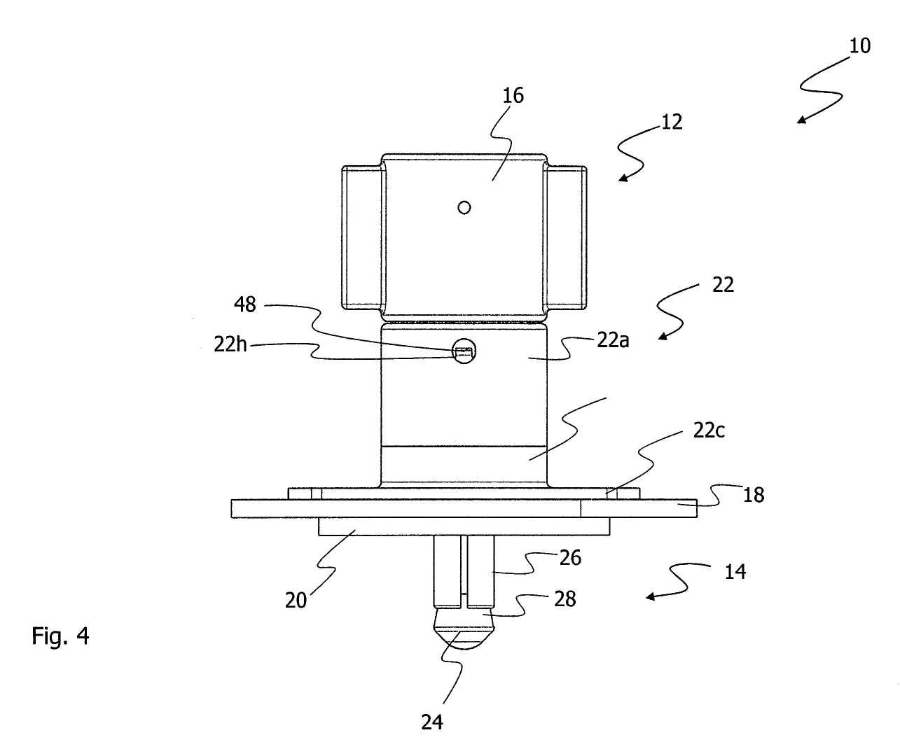

FIG. 4 shows a front view of the attachment device 10.

In FIG. 4 the handle element 16 of the operating unit 12, the casing 22, the elastic element 26 and the clamping element 24 of the attachment device 10 provided with the conical section 28 are shown. The opening 22h, through which the section 48 of the spring element 46 extends, is recognized in the casing element 22a.

The attachment device 10 abuts on the attachment structure 20 via the base element 18, in order to connect the components (not shown) affixed to the base element 18 to the attachment structure 20.

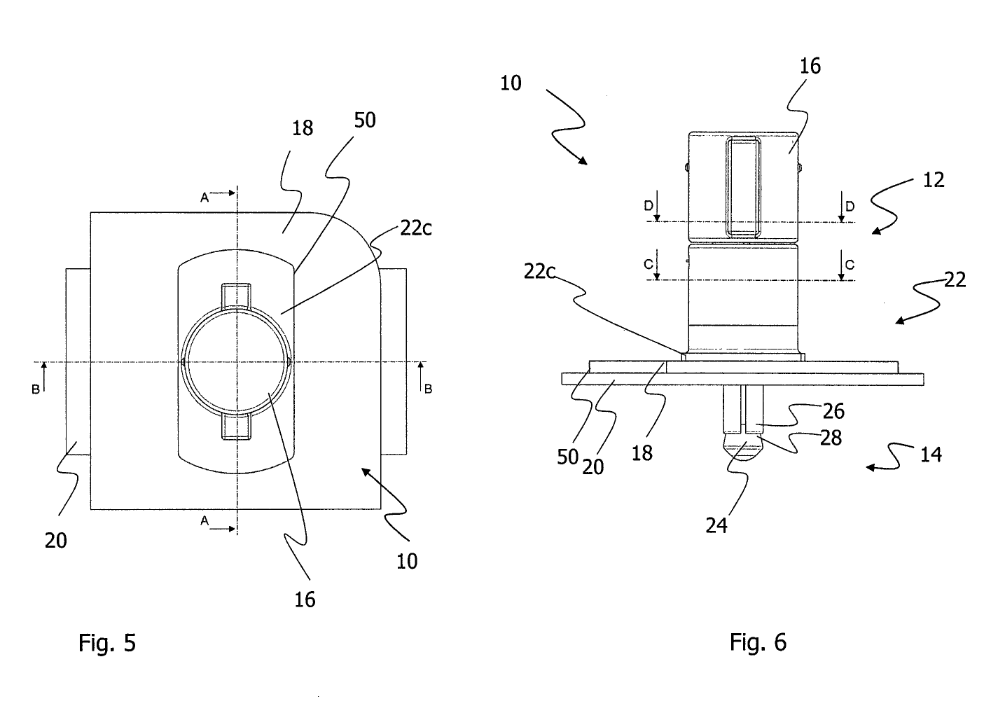

FIGS. 5 and 6 show a side view and a top view of the attachment device 10, in which the plate-shaped form of the flange section 22c in particular is seen. The flange section 22c extends, starting out from the casing section 22b, in sections in a radial direction. The peripheral edges 50 of the flange section 22c comprise sections running in parallel, which are connected by rounded sections.

FIG. 7 shows a sectional view of the attachment device 10 along the line of intersection A-A from FIG. 5.

Among other things, the threaded connection in the connection area 36 between the shaft section 32 of the operating unit 14 and the clamping element 24 of the clamping unit 14, which element is executed as a stepped shaft, is recognizable in FIG. 7. The clamping element 24 is provided with an external thread and the shaft section 32 with an internal thread.

The self-locking mechanism 42 is further recognizable in the casing part 22a in FIG. 7. The projections 52 on the spring element 46 are suggestively recognizable in FIG. 7, which projections engage in the teeth of the toothed wheel section 44 extending radially on the shaft section 32 to produce the self-locking.

The elastic element 26 with its end section 26b with an enlarged cross-section is mounted via the retaining ring 27 in the casing part 22b formed to be stepped and/or in a recess 22f in this casing part 22b, in order to secure the elastic element 26 in an axial direction.

FIG. 8 shows a sectional view along the line of intersection B-B from FIG. 5.

As in FIG. 2, the pin 34 is seen in FIG. 8, which pin extends through the handle element 16 as well as through the shaft section 32 taken up in sections in the handle element 16 and in this way connects the handle element 16 to the shaft section 32 of the operating unit 12.

The opening 22h, through which a section 48 of the spring element 46 protrudes, is recognizable again in the casing part 22a. The section 48 is used for positioning of the spring element 46 as well as to prevent twisting of the spring element 46 together with a rotation of the operating unit 12.

The clamping element 24 formed in the shape of a stepped shaft has a section 54 with a flat area 56 (see FIGS. 9 and 10), i.e., in the section 54 the clamping element 24 is not circular. The flat area 56 interacts with the opening 22e in the casing part 22b, in order to form an anti-twist guard for the clamping element 24. The opening 22e is likewise provided with a flattened section (not shown) corresponding to the clamping element 24 to this end. It is ensured by the anti-twist guard formed by the flat area 56 and the opening 22e that the clamping element 24 can only be displaced in the direction of its longitudinal axis L.

In other words, the shaft section 32 of the operating unit 12 is supported rotatably and the clamping element 24 only supported displaceably in an axial direction in the casing 22. Via the threaded connection between the shaft section 32 and the clamping element 24 and the anti-twist guard described above, a rotary movement of the operating unit 12 about the longitudinal axis of the clamping element 24 can be converted into an axial movement of the clamping element 24 for expansion of the elastic element 26.

FIG. 9 shows a sectional view of the attachment device 10 along the line of intersection C-C from FIG. 6.

In FIG. 9, the toothed wheel section 44 on the shaft section 32, which engages with the projections 52 of the spring element 46, is seen clearly. The spring element 46 is taken up under pretensioning in the groove 22g of the casing part 22a, so that the projections 52 of the spring element 46 exert a pretensioning force on the toothed wheel section 44, which must be overcome to operate the attachment device 10 via the operating unit 12.

The spring element 46 is formed in the form of a spring strip, which is supported by a locating section 46a and by its two end sections 46b, 46c on the inner peripheral surface of the groove 22g. Between the locating section 46a and the end sections 46b and 46c, the arms 46d of the spring element extend outside the groove 22g under pretensioning in sections along the toothed wheel section 44. Due to this structural design of the spring element 46, which is supported by the sections 46a, 46b and 46c on the groove 22g, the arms 46d are pretensioned in the direction of the toothed wheel section 44, so that the projections 52 engage with the teeth of the toothed wheel section 44.

The flat area 56 on the clamping element 24 is further recognizable in FIG. 9.

FIG. 10 shows a sectional view along the line of intersection D-D from FIG. 6. The handle element 16 of the operating unit 12, in which the casing part 22a is partially (see FIG. 8) taken up, is recognizable. The shaft section 32, which extends in sections through the casing part 22a, is, as can be seen in FIG. 10, connected to the clamping element 24 via a threaded connection, so that a rotary movement of the operating unit 12 about the longitudinal axis of the clamping element 24 leads to a displacement of the clamping element 24 in an axial direction.

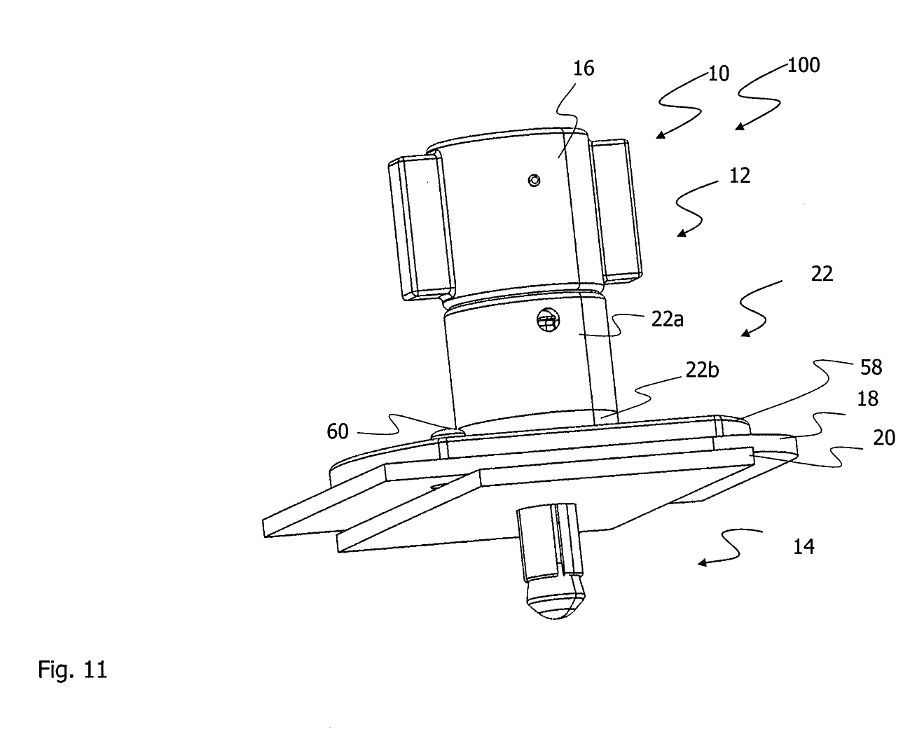

FIG. 11 shows a view in perspective of an attachment arrangement 100 according to the invention, which in addition to the attachment device 10 also comprises a covering element 58. The covering element 58 is connected via attachment means 60, such as e.g., rivets, to the base element 18 and takes up the flange section 22c. Only the features of the attachment arrangement 100 that have not been described previously are described below. With regard to the features of the attachment device 10, reference is made to the description above of FIGS. 1 to 11.

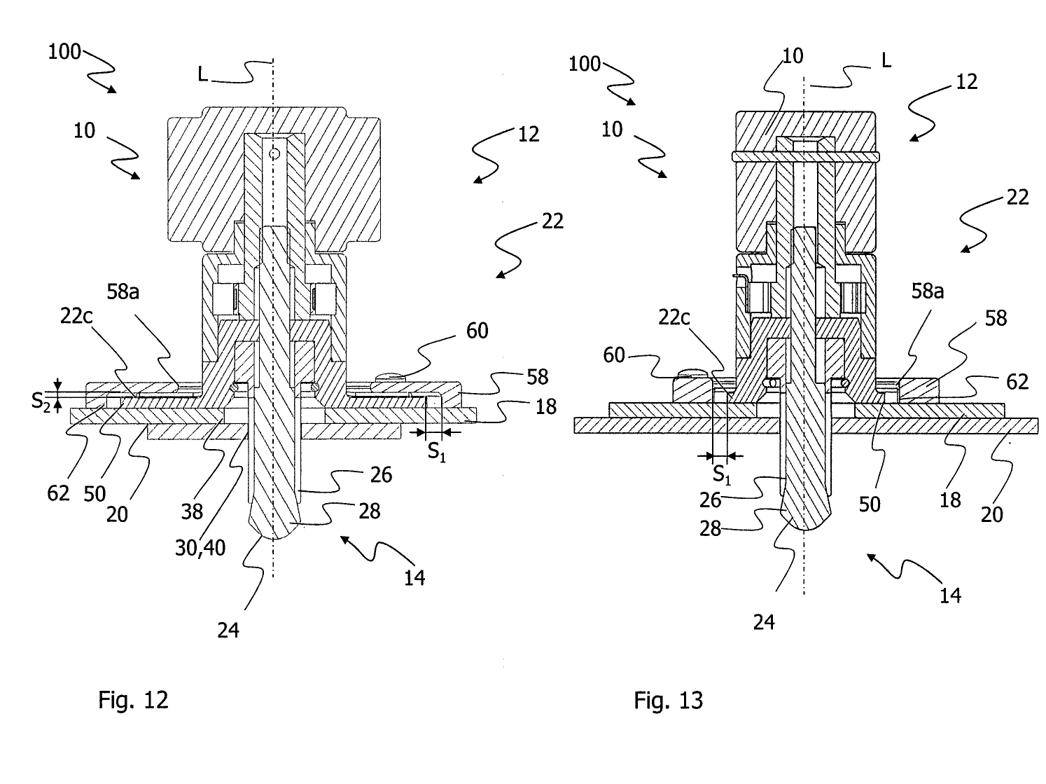

FIG. 12 shows a sectional view of the attachment arrangement 100. The line of intersection runs along the line of intersection A-A from FIG. 5. FIG. 12 corresponds to FIG. 7 as far as the representation of the attachment device 10 is concerned, the covering element 58 additionally being shown in section in FIG. 12. To avoid repetitions, reference is made to the above statements about the attachment device 10 made with reference to FIG. 7. The same applies to the description of FIGS. 13 to 15, which likewise correspond to the FIGS. 8 to 10 apart from the covering element 58.

The covering element 58 is connected via the attachment means 60 to the base element 18. The covering element 58 also has an opening 58a, through which the attachment device 10 extends. The flange section 22c of the casing part 22b is taken up with a play S1 in a radial direction and with a play S2 in an axial direction of the attachment device 10 in the covering element 58. Due to the play S1 in a radial direction and the play S2 in an axial direction it is achieved that the attachment device 10 is taken up displaceably up to a certain degree in an axial direction and a radial direction in a recess 62 in the covering element 58. The play S2 in an axial direction is chosen to be smaller here than the play S1 in a radial direction, as the play S2 is only to be used to permit a displacement of the attachment device 10 in a radial direction.

The width of the opening 58a in the covering element 58 is also coordinated to the play S1. Since the play S1 is to be used in particular for tolerance compensation of production and fitting tolerances of the attachment structure 20, the diameter of the opening 30 in the base element 18 is coordinated to the play S1, so that the attachment device 10 can be taken up displaceably in the recess 62 of the covering element 58. Expressed another way, the diameter of the opening 30 is chosen according to the play S1, in order to facilitate a floating mounting of the attachment device 10 in the covering element 58 for tolerance compensation on the part of the attachment structure 20.

FIG. 13 is a sectional view along the line of intersection B-B from FIG. 5. The play S1 is recognizable again in FIG. 13 also, which play is present between the peripheral edges 50 of the flange section 22c and the covering element 58. The flange section 22c is taken up accordingly with a surrounding radial play S1 in the recess 62 of the covering element 58.

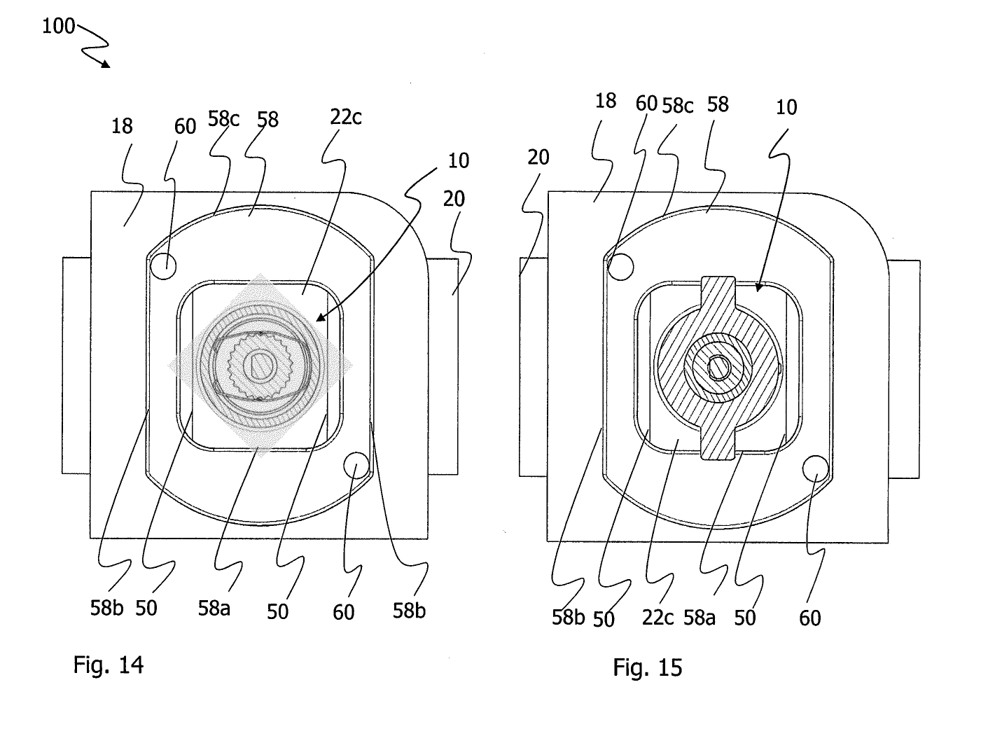

In FIGS. 14 and 15 the plate-shaped form of the covering element 58 is seen, which has two parallel peripheral surfaces 58b, between which rounded peripheral surfaces 50c extend. The flange-like section 22c of the casing 22 is adapted to the shape of the covering element 58, so that the parallel sections of the peripheral edges 50 are recognizable, i.e., are not covered by the covering element 58.

It remains to be mentioned further that individual components of the attachment arrangement 100 can be executed to be electrically conductive, in order to be able to conduct a short-circuit current of the apparatuses safely to the attachment structure 20. To do this, the base element 18, the casing 22 and the elastic element 26 of the attachment device 10, the covering element 58 and the attachment means 60 are formed or coated to be electrically conductive, for example. A short-circuit current coming from the components can thereby be conducted to the attachment structure 20 even in the case that the attachment structure 20 is formed or coated conductively only in the peripheral area of the opening 30. In this case, the short-circuit current flows from the base element 18 via the covering element 58 and the attachment means 60 to the casing 22 and finally via the elastic element 26 to the attachment structure 20.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. An attachment device for attachment of components to an attachment structure of a means of transport having:
a clamping unit for introduction into an opening of the attachment structure, and
an operating unit connected to the clamping unit for operating the clamping unit,
the clamping unit comprising at least one clamping element and at least one elastic element, wherein the at least one elastic element is expandable by a relative movement between the at least one clamping element and the at least one elastic element in an axial direction of the at least one clamping element.

2. The attachment device according to claim 1, wherein the clamping unit and the operating unit are connected to one another in such a way that a rotary movement of the operating unit about its axis of rotation leads to a displacement of the clamping element in an axial direction.

3. The attachment device according to claim 1, wherein the operating unit comprises at least one shaft section, which is connected to the at least one clamping element via a threaded connection.

4. The attachment device according to claim 3, wherein the attachment device comprises at least one casing in which the at least one shaft section of the operating unit is supported rotatably and the clamping element executed in the form of a shaft is supported displaceably in an axial direction.

5. The attachment device according to claim 4, wherein the shaft section of the operating unit has at least one projection extending outwards in a radial direction, which can be brought to engage with at least one pretensioned spring element arranged at least in sections on an inner peripheral surface of the at least one casing.

6. The attachment device according to claim 4, wherein provided on the inner peripheral surface of the at least one casing is at least one projection extending radially inwards, which can be brought to engage with at least one pretensioned spring element arranged at least in sections on an outer peripheral surface of the at least one shaft section of the operating unit.

7. The attachment device according to claim 1, wherein the at least one clamping element has at least one section with an increasing cross-section for expansion of the elastic element.

8. The attachment device according to claim 1, wherein the elastic element is in the form of a spring cage and at least partially encompasses the at least one clamping element.

9. The attachment device according to claim 1, wherein the at least one of the at least one elastic element has at least one of a corrugated outer peripheral surface and an enlarged cross-section in at least one section.

10. The attachment device according to claim 1, wherein at least one of the at least one casing and the at least one elastic element is electrically conductive.

11. An attachment arrangement for attachment of components to an attachment structure of a means of transport, in particular to an attachment structure of an aircraft, having:
at least one base element provided with at least one opening, to which element the components to be attached are affixed,
at least one attachment device according to claim 1, wherein the clamping unit of the at least one attachment device is introduced at least in sections into the at least one opening of the base element, and
at least one covering element, which is assigned to the at least one attachment device and can be affixed to the base element.

12. The attachment arrangement according to claim 11, wherein the at least one covering element accommodates at least one section of the at least one attachment device with play, and wherein the diameter of the at least one opening of the at least one base element is chosen according to this play.

13. The attachment arrangement according to claim 12, wherein the covering element comprises a recess, which is formed such that a section of the casing extending at least in sections in a radial direction can be taken up with play in a radial and axial direction in the recess.

14. The attachment arrangement according to claim 11, wherein the attachment arrangement comprises a plurality of attachment devices according to claim 1, wherein at least one attachment device of the plurality of attachment devices is taken up with play in the covering element assigned to it and at least one further attachment device of the plurality of attachment devices is taken up immovably in the covering element assigned to it.

15. The attachment arrangement according to claim 11, wherein the covering element is connected fixedly via attachment means to the base element, and wherein at least one of the covering element and the attachment means are electrically conductive.
